(19) United States
(12) Patent Application Publication
(10) Pub. No.: US 2007/0285280 A1
(43) Pub. Date: Dec. 13, 2007

(54) Providing toll services utilizing a cellular device

(75) Inventors: Benjamin P. Robinson, Plano, TX (US); Sarath K. Balachandran, Irving, TX (US)

Correspondence Address: RG & ASSOCIATES, 1103 TWIN CREEKS, STE. 120, ALLEN, TX, 75013, US

(73) Assignee: Rent-A-Toll, Ltd., Plano, TX (US)

(21) Appl. No.: 11/810,752

(22) Filed: Jun. 7, 2007

Related U.S. Application Data
(60) Provisional application No. 60/811,801, filed on Jun. 7, 2006.

(51) Int. Cl. G08G 1/065

(52) U.S. Cl. 340/928

(57) ABSTRACT

A method, system, and computer readable medium comprising, communicating between a cellular carrier and the cellular device, wherein the communicating includes at least one of a following information: an identifier of the cellular device, transport data, a time stamp, a toll location, and a location of the cellular device, determining by the cellular carrier if the cellular device location is within a toll collection subscribed area, if the cellular device location is within the toll collection subscribed area, sending the information by the cellular carrier to a toll service provider, receiving toll usage data by the toll service provider from a toll authority, and paying the toll authority an amount related to the toll usage by the toll service provider based on the information and the data.

### CROSS-REFERENCE TO RELATED APPLICATIONS

The present patent application is related to and claims priority from U.S. provisional patent application No. 60/811,801, filed Jun. 7, 2006, entitled LOCATION BASED ON-DEMAND TOLL SYSTEM AND METHOD USING CELLULAR COMMUNICATIONS, the entire contents of which are incorporated by reference herein.

The present patent application is related to U.S. Provisional Patent Application No. 60/757,406, titled Online Travel Provider Toll System And Method, filed on Jan. 9, 2006, U.S. Provisional Patent Application No. 60/757,347, titled Electronic Toll Payment System And Method For Third Party Operated Vehicles Utilizing An Onboard Unit, filed on Jan. 9, 2006, U.S. Provisional Patent Application No. 60/757,405, titled GPS Toll System And Method For Collection Of Rental Vehicle Tolls, filed on Jan. 9, 2006, U.S. Provisional Patent Application No. 60/726,300, titled Toll Fee System And Method Using Prepaid Toll Pass, filed on Oct. 13, 2005, U.S. Provisional Patent Application No. 60/759,937, titled Business Process For Toll Fee System And Method For Vehicle Registration, Invoicing, Opt-In Services, And Toll Violations, filed on Jan. 18, 2006, U.S. Provisional Patent Application No. 60/763,097 titled Method And System For Toll Collection With Optional Service Capabilities, filed on Jan. 27, 2006, U.S. Non-Provisional patent application Ser. No. 11/125,521, titled Toll Fee System And Method, filed on May 10, 2005, to U.S. Non-Provisional Patent Application Docket No. RTL008, titled System, Method, And Computer Readable Medium For Billing, filed on Sep. 6, 2006, to U.S. Non-Provisional Patent Application Docket No. RTL009, titled System, Method, And Computer Readable Medium For Billing Tolls, filed on Sep. 6, 2006, to U.S. Non-Provisional Patent Application Docket No. RTL010, titled System, Method And Computer Readable Medium For Toll Service Activation And Billing, filed on Oct. 13, 2006, to U.S. Non-Provisional Patent Application Docket No. RTL010A, titled System, Method And Computer Readable Medium For Billing Based On A Duration Of A Service Period, filed on Oct. 13, 2006, to U.S. Non-Provisional Patent Application Docket No. RTL030, tilted Paying Tolls Utilizing A Financial Service Provider And Paying A Subscription Or License Fee, filed on Dec. 18, 2006, to U.S. Non-Provisional Patent Application Docket No. RTL030A, titled Transferring Toll Data From A Third Party Operated Transport To A User Account, filed on Dec. 18, 2006, and to U.S. Non-Provisional Patent Application Docket No. RTL031, titled Determining A Toll Amount, filed on May 16, 2007 the entire contents of each of which are incorporated by reference herein

### BACKGROUND OF THE INVENTION

The present invention relates generally to toll service systems and methods and, more particularly, but not by way of limitation, to toll service systems, methods, and computer readable media for providing cellular phone or cellular device customers the ability to use on-demand or subscription based toll services through a toll service provider.

The use of cellular phones is wide-spread and the functions provided by them are ever increasing. Similarly, the use of toll roads by various transports such as cars, motorcycles, and the like, and the construction of such toll roads, continues to expand. As such, it is desirable to utilize a cellular phone while engaging with a toll road to provide a seamless experience for a user or owner of a transport.

Therefore, there is a need for a method, system, and computer readable medium for providing toll services utilizing a cellular device.

### SUMMARY OF THE INVENTION

The present invention provides a number of toll services to customers including using a cellular phone to register for, pay for, and wirelessly engage with a toll road. In one embodiment, a method includes the steps of receiving, by a cellular customer, a message from a cellular service provider notifying the cellular customer of toll service availability. The method further includes the step of replying, by the cellular customer, to the cellular service provider to opt-in or opt-out for the toll services. If the customer opts-in, the transport of the customer is driving or is a passenger in, can pass over the toll road as all transactions are performed through the customer's cellular phone. The above summary of the invention is not intended to represent each embodiment or every aspect of the present invention.

In one embodiment, a method for toll collection using a cellular device comprises communicating between a cellular carrier and the cellular device, wherein the communicating includes at least one of a following information: an identifier of the cellular device, a time stamp, a toll location, and a location of the cellular device, determining by the cellular carrier if the cellular device location is within a toll collection subscribed area, if the cellular device location is within the toll collection subscribed area, sending the information by the cellular carrier to a toll service provider, receiving toll usage data by the toll service provider from a toll authority, and paying the toll authority an amount related to the toll usage by the toll service provider based on the information and the data.

In another embodiment, a computer readable medium comprises instructions for: determining by a cellular carrier if a cellular device location is within a toll collection subscribed area by communicating between the cellular carrier and the cellular device, wherein the communicating includes at least one of a following information: an identifier of the cellular device, a time stamp, a toll location, a location of the cellular device, and transport data, wherein the transport is associated with the cellular device, sending at least one of the information by the cellular carrier to a toll service provider, and paying a toll authority an amount related to toll usage by the toll service provider based on the information and the data.

In a further embodiment, a system comprises a module that: receives transaction information from a cellular carrier, sends the transaction information to a toll authority, receives toll usage information from the toll authority, matches the toll usage information with a transport associated with a cellular device that communicates via the cellular carrier, and pays the toll authority for the toll service.

### BRIEF DESCRIPTION OF THE DRAWINGS

FIG. 1 illustrates a first system diagram and message flow for providing toll services according to an embodiment of the disclosure;

FIG. 2 illustrates a second system diagram and message flow for providing toll services according to an embodiment of the disclosure;

FIG. 3 illustrates a flow chart of invoicing or billing actions according to an embodiment of the disclosure.

FIG. 4 illustrates a third system diagram and message flow for providing toll services according to an embodiment of the disclosure;

FIG. 5 illustrates a first flow chart for providing toll services according to an embodiment of the disclosure;

FIG. 6 illustrates a second flow chart for providing toll services according to an embodiment of the disclosure; and

FIG. 7 illustrates a fourth system diagram and message flow for providing toll services according to an embodiment of the disclosure.

### DETAILED DESCRIPTION OF THE INVENTION

Embodiments of the present invention provide a system, method, and computer readable medium for providing toll services using a cellular device such as a cellular phone or any device capable of sending and/or receiving a cellular signal or information.

The present invention can be used to provide cellular phone customers an ability to use on-demand or subscription based Toll services through a Toll Service Provider (TSP) when traveling out of their local Toll market where their cellular service is set up. A cellular customer can use the on-demand or subscription based Toll services by replying to a message received from the cellular service provider. The message may be of either voice/data, for example, a text message, an e-mail message, or a phone call. The reply message includes vehicle information such as License plate/electronic VIN, etc, of the vehicle in which the customer is traveling. The vehicles may be, for example, a personal vehicle, a rental vehicle, or a borrowed vehicle. The on-demand or subscription based Toll services will be resold/licensed/serviced by the cellular service provider through a cellular carrier network. Cellular service providers use satellite towers to identify the geographic location of customers. This type of location identification helps to identify if the customer is roaming or within a coverage toll area. According to embodiments of the present invention, the same cellular tower will be used to identify the location of a driver of a vehicle. For example, when a cellular customer travels from Dallas which may be, for example, a home zone to Chicago which may be, form example, a visitor zone, the cellular tower in Chicago immediately recognizes the cellular phone signal when the customer turns on the cellular phone.

According to embodiments of the present invention, location identification information is sent to a Toll Service Provider or checked against a database internal to the cellular service provider's network to determine if the visitor zone has Toll Services available through the TSP. If it is determined that the visitor zone does have Toll Services available, a message is created by the cellular service provider to notify the customer of toll service availability. The customer then replies to the message with a decision to Opt-in or Opt-out for the service. If the customer fails to respond to the message, then the customer is considered an Opt-Out.

According to embodiments of the present invention, it is also possible to be a subscriber of Toll Services anywhere those services are provided. Thus, if a customer is a Toll Services subscriber, then anytime the customer enters a visitor zone where Toll Services are available, the customer receives a message by the cellular service provider. The customer replies to the received message with license plate/vehicle information to allow coverage for the period to be applied to that vehicle. This allows for the use of services in multiple markets. When the cellular phone begins to use a cell tower in any visitor zone, the TSP will receive notification that the customer has entered a new market and authorization for the new market will be sent via the TSP to the new Toll Authority.

Embodiments of the invention allow for all tolls to be applied back to the cellular service provider for billing on a monthly basis in the customer's cellular phone bill. In another embodiment, the TSP might directly charge the user of the vehicle or the vehicle owner. The TSP will accumulate tolls for the same period that the cell phone is located in the Toll Authority visitor zone. When the cell phone leaves the visitor zone and enters the home zone for the customer, a notification will be sent from the cellular service provider via the TSP to the Toll Authority to deactivate further service for the license plate which the customer registered at the time it entered the visitor zone.

According to embodiments of the present invention, the system and method as disclosed above allows registration of multiple vehicles on a single cellular phone account during the period is which the cellular customer is located in the home/visitor zone. Thus, a family using two vehicles can register both license plates with the same cellular phone account during travels in the home/visitor zone.

The TSP will communicate to the Toll Authority a begin time and an end time of the service as well as the communication of which vehicle (license plates) are valid in the home/visitor zones during the given period. The vehicle information such as license plates/electronic VIN will be read by Violation Enforcement Systems (VES) and all toll fees are forwarded to the TSP to apply to the cellular phone account when the transactions are completed. The TSP will be responsible for all payments to the Toll Authority for the given vehicle license plate during the given period in which the cell phone customer is located in the home/visitor zone. The embodiments as disclosed above require no engagement with rental car agencies for the service to be available to the vehicle renter. This model is a direct model with the end user and is leveraged by the relationship of the cellular service provider to the customer desiring to use the services.

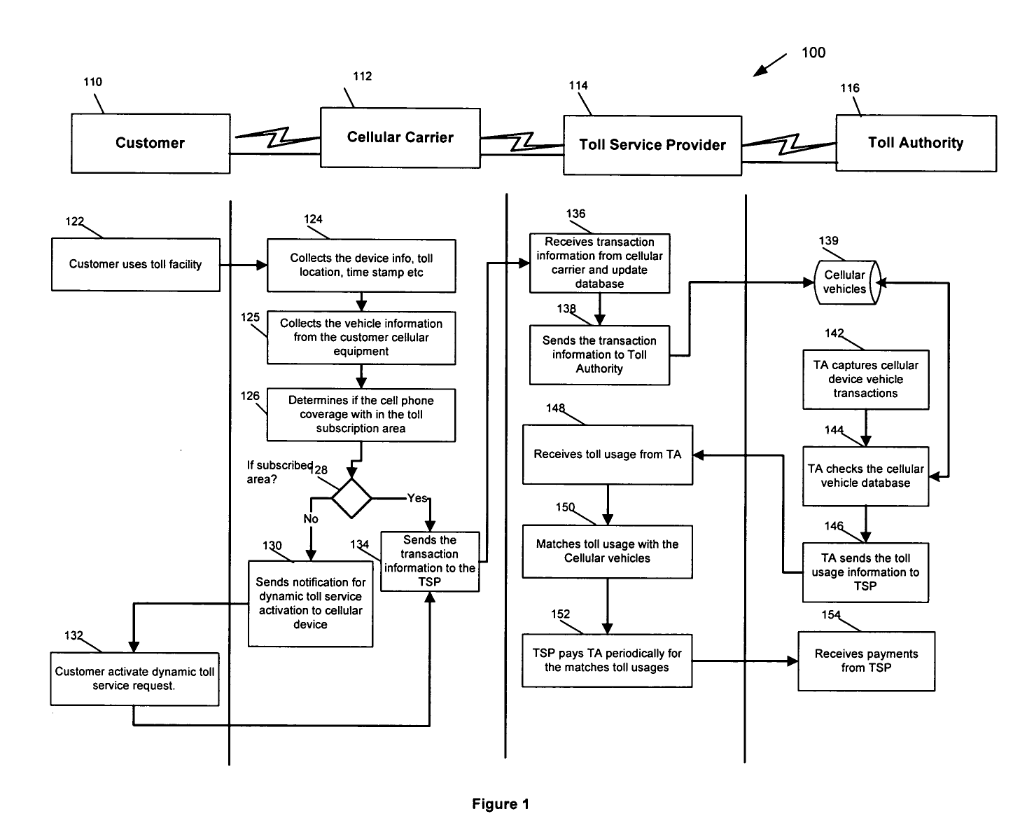

Referring now to FIG. 1, a system 100 includes a cellular carrier 112, a toll service entity or a toll service provider 114, and a toll authority 116 which are communicably coupled to one another via a wired connection, a wireless connection, and/or a combination of the two. In other embodiments, the cellular carrier 112 can communicate directly with the toll authority 116. When a customer 110 (which can also communicate directly with any of the above noted entities), uses the toll facility 122, the cellular carrier 112 identifies when the cellular device goes though the toll plaza or passes toll equipment using cellular technologies. The cellular carrier 112 collects 124 at least one of: cellular device information (such as SIM information, a mobile identification number, etc.), toll facility information, location information (of the cellular device, of the toll equipment, and/or of the transport), time stamp information of a transaction involving the toll equipment, and an amount of the transaction. The cellular carrier 112 sends the acknowledgement notification to the customer's cell device for vehicle confirmation 125 with the toll location information. If the customer is using the different vehicle, then customer might provide the vehicle information such as license plate, license state, etc. for the toll usage. The cellular carrier 112 determines 126 if the cellular phone has coverage within the toll subscription area. If so, the cellular carrier 112 receives the acknowledgement message from the customer's cell phone and sends 134 the toll usage information and vehicle information to the Toll Service Entity 114. If the toll location is not part of the subscribed toll coverage by the customer 128, the cellular carrier 112 sends 130 the notification message to the customer 110 if the customer is not in the subscribed area. The customer 110 will be able to dynamically opt-in 132 for the toll service at this location and if so, the relevant information is sent 134 to the Toll Service Provider 114.

Toll Service Entity 114 receives 136 the transaction information and updates a cellular vehicle database with the vehicle information (license plate, license state, vehicle type, etc.), customer information (for billing), toll usage information received from the cellular carrier, etc. The Toll Service Entity 114 sends 138 the toll usage information to the Toll Authority 116 which stores this information in a database 139. The Toll Authority 116 captures 142 cellular device vehicle transactions and checks 144 the database 139 for sending 146 the actual toll utilized by the customer for payment to the Toll Service Entity 114. The Toll Service Entity 114 receives 148 the toll charges information from the Toll Authority 116 and matches 150 the toll usage from the cellular carrier and the toll authority for paying toll charges to the toll authority. The Toll Service Provider 114 pays 152 the Toll Authority 116 for the toll service. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

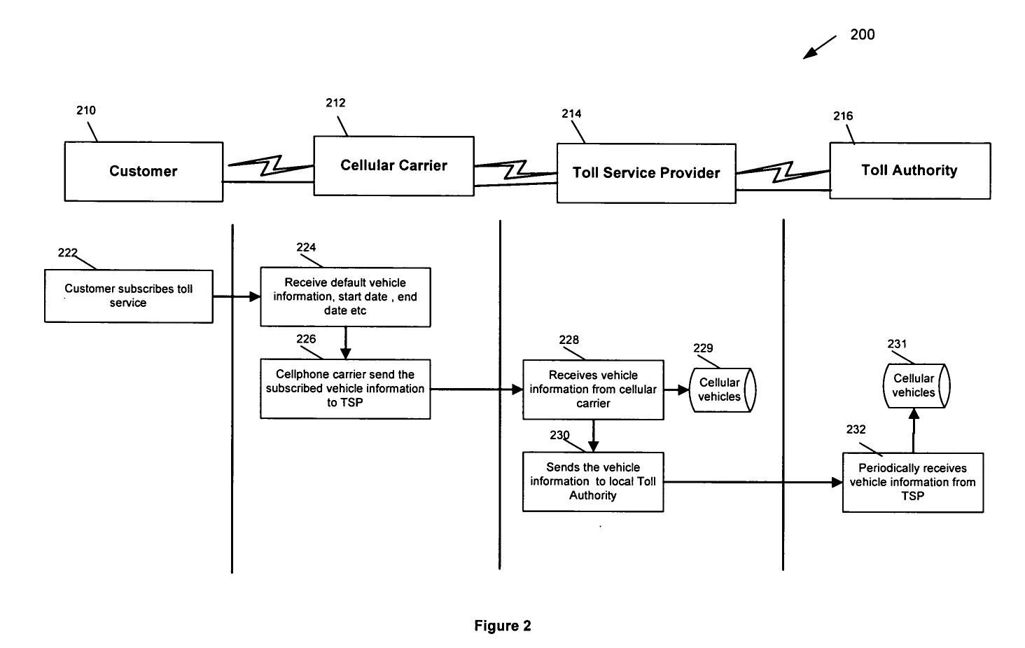

Referring now FIG. 2, a system 200 includes a cellular carrier 212, a toll service entity or a toll service provider 214, and a toll authority 216 which are communicably coupled to one another via a wired connection, a wireless connection, and/or a combination of the two. In other embodiments, the cellular carrier 212 can communicate directly with the toll authority 216. A customer 210 (which can also communicate directly with any of the above noted entities), subscribes for toll service to the cellular carrier 212. The customer 210 provides and the cellular carrier 212 receives 224 information such as vehicle information, toll location information for default subscription of the toll service. The cellular carrier 212 sends 226 the subscription information to the Toll Service Entity 214 for activation. The Toll Service Entity 214 receives 228 the activation request from the cellular carrier periodically and maintain the cellular vehicle database 229 for the toll services. Based on the location or region, the Toll Service Entity 214 sends 230 the vehicle information to the Toll Authority 216 for the toll service. The Toll Authority 216 receives 232 this information and maintains the toll service vehicles for later processing in a database 231. Whenever the Toll Authority receives any toll transaction for a vehicle for a particular period, it sends the toll usage information to the toll service entity. When a customer uses third party vehicles (such as a rental car) or temporary vehicles, the customer might send the vehicle information along with the vehicle usage period such as start date/time and end date/time. The Toll Service Entity 214 maintains the vehicles for the customer and also sends the vehicle information to the toll authority for collecting the toll usage. In this case, matching will be performed based on a time line. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

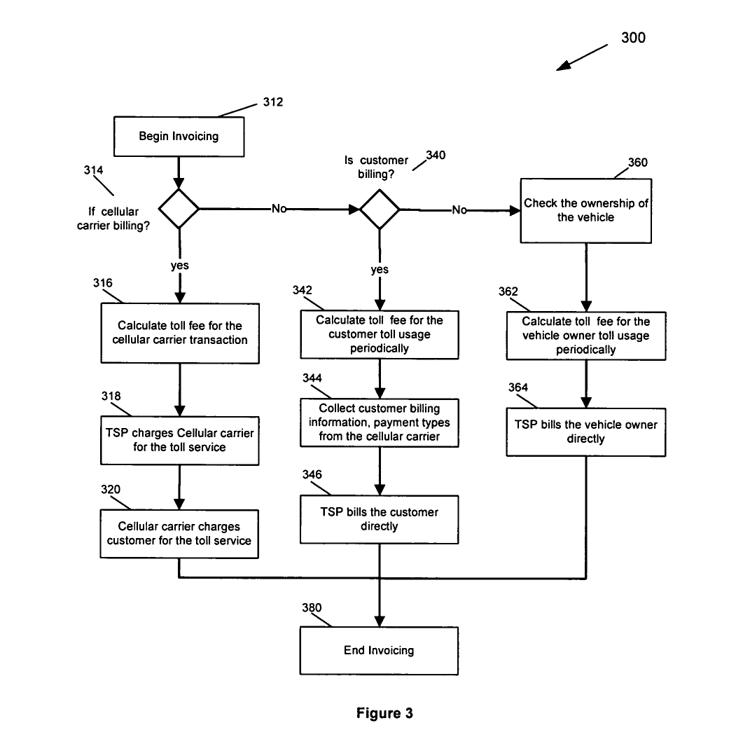

Referring now FIG. 3, an invoicing process 300 is depicted. There are three types of invoicing process involved with the toll service including: cellular carrier billing 314, customer billing 340 and vehicle owner billing 360. If the invoicing process involves cellular carrier billing, a toll fee is calculated 316 for the cellular carrier transaction, a toll service provider charges 318 the cellular carrier for the toll usage made by the customer and the cellular carrier charges 320 the customer for the toll service. Billing may be based on duration, transaction, service fee, etc. In a customer billing option 340, a toll fee is calculated 342 for a customer toll usage, the Toll Service Entity collects 344 the customer information of the transaction from the cellular carrier, and bill 346 the customer directly. The customer pays for the toll charges by duration or by transaction with a service charge included. In the third model 360, Toll Service Entity would check 360 the ownership of the vehicle, calculate 362 the toll fee for the vehicle owner toll usage, and bill 364 the vehicle owner by getting the vehicle information form the customer, vehicle owner, cellular carrier or toll authority. Toll Service Entity might use department of motor vehicle records to identity the vehicle ownership and bill the vehicle owner by duration/transaction with the service fee. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

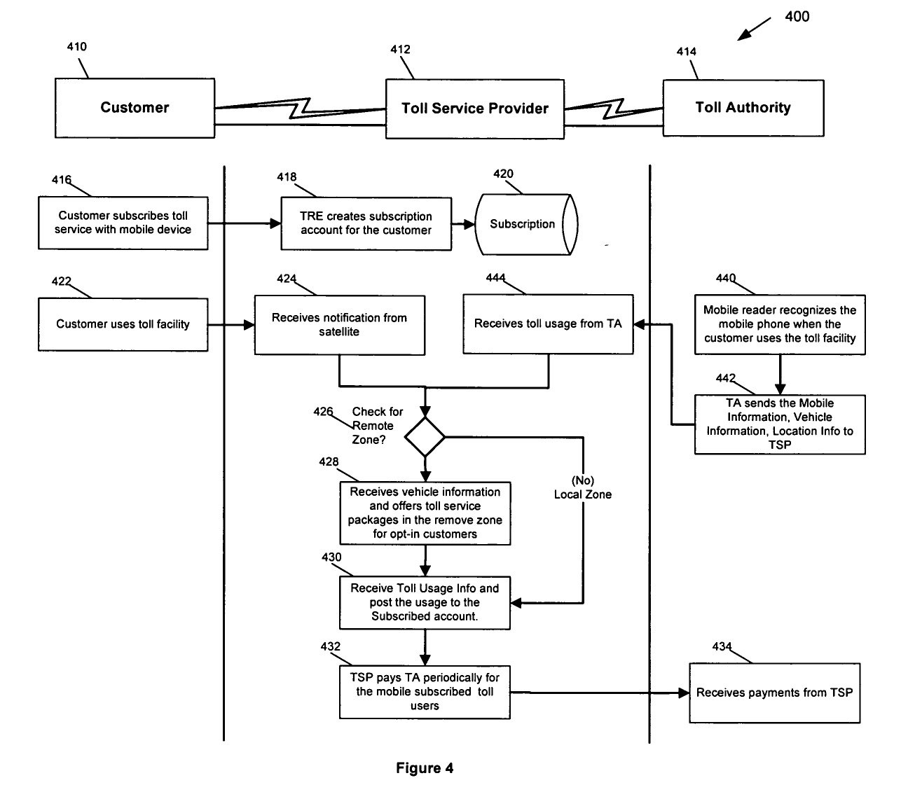

Referring now FIG. 4, a system 400 includes a toll service entity or a toll service provider 412 and a toll authority 414 which are communicably coupled to one another via a wired connection, a wireless connection, and/or a combination of the two. A customer 410 (which can also communicate directly with any of the above noted entities), subscribes 416 for toll service with a mobile device (which may be a non-cellular device) using voice, text, or DTFM tones. In the present example, the customer directly sends the toll usage information to the toll service entity 412. The customer uses the mobile device to communicate the information to the Toll Service Entity using wireless technology. The Toll Service Entity 412 creates 418 a subscription account for the customer and places this information in a database 420.

There are two modes of activation in this model including static activation (where the vehicle and the customer register as part of a subscription process) and a dynamic activation (where the customer is allowed to provide the vehicle information at the time of toll facility usage 422 or after the toll facility has been used). When the Toll Service Entity 424 receives the toll usage notification from the customer (either directly or via another device such as a satellite), it checks 426 to determine if the mobile device is in a subscribed toll location or an unsubscribed toll location. If the toll location is in an unsubscribed toll area, Toll Service Entity sends out an notification to the customer's cellular device. If the customer opts-in for the service, the request is accepted and the vehicle information, toll service package selection, etc. are sent to the Toll Service Entity 428, 430. The Toll Service Entity 412 pays 431 the toll authority 414 for the toll service. At the Toll Authority 414, a device (such as a mobile or cellular phone reader) recognizes 440 the mobile phone when the customer uses or is in proximity with the toll facility or toll equipment. The Toll Authority sends 442 mobile, vehicle, and location information to the Toll Service Entity 412. This information is received 444 and a check for a remote zone 426 ensues. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

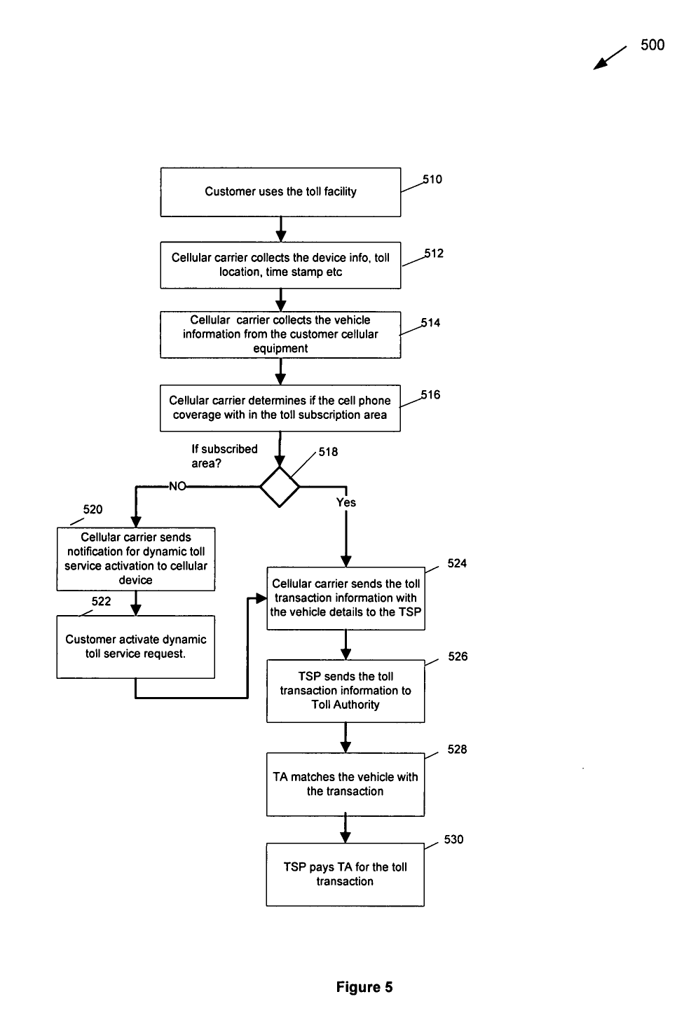

Referring now the FIG. 5, a flow chart 500 illustrates a processing of toll usage transactions received from a customer through a cellular carrier. When the customer uses a toll road or toll facility 510, the cellular carrier identifies the cellular device utilizing the toll road and collects information related to the device, toll location and time stamp 512. The cellular carrier sends the toll usage notification to the customer's device for the confirmation and the customer sends the confirmation with the vehicle information if needed 514. The cellular carrier determines if the cell phone coverage is within the toll subscribed area 516, and if it is 518, the cellular carrier sends the usage information to the Toll Service Entity 524. If the toll location is out of the subscribed location 518, the cellular carrier sends 520 the notification to the customer who can opt-in for the out of state subscription dynamically 522. The Toll Service Entity sends the vehicle information and toll location information to the toll authority for payments 526. The toll authority matches the received transaction with the actual transaction made by the vehicle and sends the confirmation back to the Toll Service Entity 528 and the Toll Service Entity pays 530 the Toll Authority for the toll service or toll usage. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

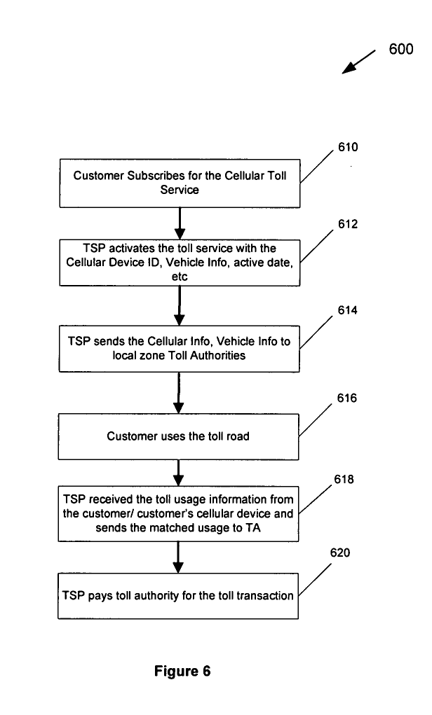

Referring now FIG. 6, a flow chart 600 for receiving toll service activation directly by a Toll Service Entity is depicted. A customer subscribes to the toll service with a Cellular Carrier 610. The Toll Service Entity activates the account for the customer using cellular device information, vehicle information, location, and the like 612, and sends the subscription information to the local/subscribed toll authorities 614. Whenever the customer uses a toll road or otherwise engages with a toll facility or equipment 616, the Toll Service Provider receives the toll usage information from the customer or the customer's cellular device and sends the matched usage to Toll Authority 618. The Toll Service Provider pays toll Authority periodically for the toll usages made by the customer who opted for the toll service 620. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

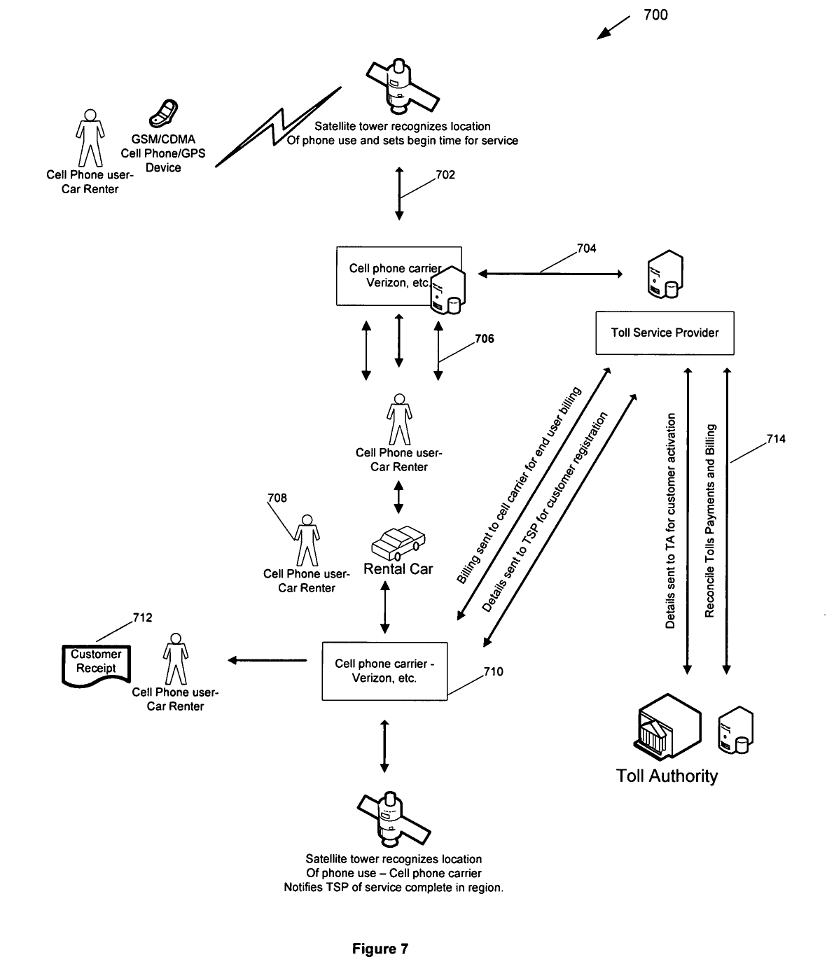

Referring now FIG. 7, a system 700 includes a satellite, a cellular phone carrier, a toll service provider, and a toll authority. Utilizing a cellular phone, a user communicates with a satellite which sends 702 the cell phone location usage data to the cell phone carrier. The cell phone carrier logs city, state, zip code, area code, etc. Based on the location where the signal was received by the user. The cell phone carrier searches a database for a phone that is roaming from its home billing address in order to determine if the customer is a potential toll service user. The cell phone carrier checks 702 a travel service provider database for location based toll services availability. This database may be external or internal to the cell phone carrier. If the database is internal to the cell phone carrier then the travel service provider is responsible for sending updates periodically for updated location availability.

The cell phone carrier notifies 706 the cell user/traveler when outside his home location for toll service availability and offers cell user various Toll services (as described in the above noted pending patent applications) while in a travel location. The cell phone carrier requests the license plate, the state of the license plate, and a type of service the customer requests to purchase. The customer may respond to the cell phone carrier via phone, email, or text. The cell user picks-up 708 a rental car and responds to the notification from the cell carrier regarding a service opt-in. The customer replies with the vehicle license plate number and the state of vehicle. This response can occur via text, online registration, voice (by a phone call to the travel service provider or to the Cell Provider). The Cell phone carrier receives 710 a notification of an opt-in for the Toll Service. Vehicle details, time, location, service type, etc. Are established with a transaction identifier. The transaction identifier and as well as relevant details are sent to the toll service provider for activation with the Toll Authority. The cell phone customer is billed 712 for Tolls on a monthly basis when the monthly bill is sent out from cell phone carrier. The customer may pay on-demand service fees for the service activation or the customer may utilize the service via a subscription whereby they are charged a monthly fee to have the service. Regardless of whether the customer is a subscription or on-demand customer, all tolls will be billed at a certain period of time (for example, at month end) and added to the customer's cell phone bill or otherwise charged to the customer's account. The Toll Service Provider notifies 714 the Toll Authority of service begin and end times for a vehicle with a particular license plate number. The Toll Service Provider communicates with the Toll Authority for tolls accumulated during the travel period based on the specific license plate. The Toll Service Provider provides a payment to the Toll Authority for such usage. The Toll Service Provider holds billing details for billing of the Cellular Provider to the customer.

In one embodiment, a method for toll collection using a cellular device comprises communicating between a cellular carrier and the cellular device, wherein the communicating includes at least one of a following information: an identifier of the cellular device, a time stamp, a toll location, and a location of the cellular device, determining by the cellular carrier if the cellular device location is within a toll collection subscribed area, if the cellular device location is within the toll collection subscribed area, sending the information by the cellular carrier to a toll service provider, receiving toll usage data by the toll service provider from a toll authority, and paying the toll authority an amount related to the toll usage by the toll service provider based on the information and the data. The method further comprises charging the cellular carrier the amount by the toll service provider, wherein the charging includes the amount and at least one of: a service charge, a transaction fee, a subscription fee, a location fee, a static fee, and a dynamic fee, comprises matching the information and the data prior to paying the amount, storing the information and the data, sending transport information from the toll service provider to the toll authority, associating the cellular device with the transport, wherein the associating is based on at least one of: period, time, and location, wherein the transport information includes at least one of: license plate information for the transport, wherein the transport is at least one of an owned transports, and a rented transport, a make of the transport, a model of the transport, a color of the transport, a year of manufacturer of the transport, an owner of the transport, and a driver of the transport, wherein if the cellular device location is not within the toll collection subscribed area, sending a subscription notification by the cellular carrier to the cellular device.

The method further comprises accepting the subscription notification by the cellular device, wherein the accepted subscription notification includes information about a transport associated with a user of the cellular device, sending the accepted subscription notification by the cellular carrier to the toll authority via the toll rental entity, paying the toll authority a toll usage amount of the transport by the toll service provider based on the accepted subscription notification, and charging the cellular carrier, by the toll service provider, at least one of: the amount, a service charge, a transaction fee, a subscription fee, a location fee, a static fee, a dynamic fee, and a toll service amount.

In another embodiment, a computer readable medium comprises instructions for: determining by a cellular carrier if a cellular device location is within a toll collection subscribed area by communicating between the cellular carrier and the cellular device, wherein the communicating includes at least one of a following information: an identifier of the cellular device, a time stamp, a toll location, a location of the cellular device, and transport data, wherein the transport is associated with the cellular device, sending at least one of the information by the cellular carrier to a toll service provider; and paying a toll authority an amount related to toll usage by the toll service provider based on the information and the data. The computer readable medium of further comprises instructions for sending the information to the toll authority by the toll service provider, matching the information by the toll authority based on the toll usage, paying the toll authority an amount related to a toll service between the toll service provider and the toll authority, billing, by the toll service provider, at least one of the following: the cellular carrier, the toll authority, an owner of the cellular device, a user of the cellular device, an owner of the transport, and a user of the transport.

In a further embodiment, a system comprises a module that: receives transaction information from a cellular carrier, sends the transaction information to a toll authority, receives toll usage information from the toll authority, matches the toll usage information with a transport associated with a cellular device that communicates via the cellular carrier, and pays the toll authority based on the matches, wherein the module collects vehicle information and toll service activation information from the cellular device.

Although an exemplary embodiment of the system of the embodiment of the disclosure has been illustrated in the accompanied drawings and described in the foregoing detailed description, it will be understood that the embodiment of the disclosure is not limited to the embodiments disclosed, but is capable of numerous rearrangements, modifications, and substitutions without departing from the spirit of the embodiment of the disclosure as set forth and defined by the following claims. For example, the capabilities of the embodiments of the disclosure can be performed fully and/or partially by one or more of the described or depicted entities or devices. Also, these capabilities may be performed in the current manner or in a distributed manner and on, or via, any device able to provide and/or receive information. Further, although depicted in a particular manner, various modules or blocks may be repositioned without departing from the scope of the current embodiment of the disclosure. Still further, although depicted in a particular manner, a greater or lesser number of modules and connections can be utilized with the embodiments of the disclosure in order to accomplish the embodiments of the disclosure, to provide additional known features to the embodiments of the disclosure, and/or to make the embodiments of the disclosure more efficient. Also, the information sent between various modules can be sent between the modules via at least one of a data network, the Internet, an Internet Protocol network, a wireless source, and a wired source and via plurality of protocols.

What is claimed is:

1. A method for toll collection using a cellular device, comprising:
communicating between a cellular carrier and the cellular device, wherein the communicating includes at least one of a following information: an identifier of the cellular device, a time stamp, a toll location, and a location of the cellular device;
determining by the cellular carrier if the cellular device location is within a toll collection subscribed area;
if the cellular device location is within the toll collection subscribed area, sending the information by the cellular carrier to a toll service provider;
receiving toll usage data by the toll service provider from a toll authority; and
paying the toll authority an amount related to the toll usage by the toll service provider based on the information and the data.

2. The method of claim 1 comprising charging the cellular carrier the amount by the toll service provider.

3. The method of claim 2, wherein the charging includes the amount and at least one of: a service charge, a transaction fee, a subscription fee, a location fee, a static fee, and a dynamic fee.

4. The method of claim 1 comprising matching the information and the data prior to paying the amount.

5. The method of claim 1 comprising storing the information and the data.

6. The method of claim 1 comprising sending transport information from the toll service provider to the toll authority.

7. The method of claim 6 comprising associating the cellular device with the transport, wherein the associating is based on at least one of: period, time, and location.

8. The method of claim 6, wherein the transport information includes at least one of:
license plate information for the transport, wherein the transport is at least one of an owned transports, and a rented transport;
a make of the transport;
a model of the transport;
a color of the transport;
a year of manufacturer of the transport;
an owner of the transport; and
a driver of the transport.

9. The method of claim 1, wherein if the cellular device location is not within the toll collection subscribed area, sending a subscription notification by the cellular carrier to the cellular device.

10. The method of claim 9 comprising accepting the subscription notification by the cellular device, wherein the accepted subscription notification includes information about a transport associated with a user of the cellular device.

11. The method of claim 10 comprising sending the accepted subscription notification by the cellular carrier to the toll authority via the toll rental entity.

12. The method of claim 11 comprising paying the toll authority a toll usage amount of the transport by the toll service provider based on the accepted subscription notification.

13. The method of claim 12 comprising charging the cellular carrier, by the toll service provider, at least one of:
the amount;
a service charge;
a transaction fee;
a subscription fee;
a location fee;
a static fee;
a dynamic fee; and
a toll service amount.

14. A computer readable medium comprising instructions for:
determining by a cellular carrier if a cellular device location is within a toll collection subscribed area by communicating between the cellular carrier and the cellular device, wherein the communicating includes at least one of a following information: an identifier of the cellular device, a time stamp, a toll location, a location of the cellular device, and transport data, wherein the transport is associated with the cellular device;
sending at least one of the information by the cellular carrier to a toll service provider; and
paying a toll authority an amount related to toll usage by the toll service provider based on the information and the data.

15. The computer readable medium of claim 14 comprising instructions for sending the information to the toll authority by the toll service provider.

16. The computer readable medium of claim 14 comprising instructions for matching the information by the toll authority based on the toll usage.

17. The computer readable medium of claim 14 comprising instructions for paying the toll authority an amount related to a toll service between the toll service provider and the toll authority.

18. The computer readable medium of claim 14 comprising instructions for billing, by the toll service provider, at least one of the following:
the cellular carrier;
the toll authority;
an owner of the cellular device;
a user of the cellular device;
an owner of the transport; and
a user of the transport.

19. A system, comprising:
a module that:
receives transaction information from a cellular carrier;
sends the transaction information to a toll authority;
receives toll usage information from the toll authority;
matches the toll usage information with a transport associated with a cellular device that communicates via the cellular carrier; and
pays the toll authority based on the matches.

20. The system of claim 19, wherein the module collects vehicle information and toll service activation information from the cellular device.
